(19) United States
(12) Patent Application Publication
(10) Pub. No.: US 2022/0406272 A1
(43) Pub. Date: Dec. 22, 2022

(54) DRIVING METHOD OF DISPLAY PANEL DRIVING SYSTEM AND STORAGE MEDIUM

(71) Applicant: TCL China Star Optoelectronics Technology Co., Ltd., Shenzhen (CN)

(72) Inventors: Meng LEI, Shenzhen (CN); Jilong LI, Shenzhen (CN)

(21) Appl. No.: 17/253,132

(22) PCT Filed: Apr. 3, 2020
(86) PCT No.: PCT/CN2020/083099

§ 371 Date: Dec. 17, 2020

(30) Foreign Application Priority Data
Mar. 6, 2020 (CN) 202010150057.5

(51) Int. Cl. G09G 5/18

(52) U.S. Cl. CPC G09G 5/18; G09G 2310/08; G09G 2370/10

(57) ABSTRACT

A driving method of a display panel is provided, by pre-storing a new setting information of a source output enable signal in a peer-to-peer protocol, and detecting a default setting information of the source output enable signal, and according to a detection result of the default setting information, invoking the new setting information when switching different drivers, a setting information of the source output enable signal in the peer-to-peer protocol can be unified, thereby avoiding the charging time difference due to a replacement of drivers.

### BACKGROUND OF INVENTION

### Field of Invention

The present application relates to the field of display panel technology, and particularly to a driving method of a display panel, a driving system of the display panel, and a storage medium.

### Description of Prior Art

With the increase of LCD panel resolution and brush frequency, high-speed peer-to-peer (P2P) protocol is gradually being widely used. Numerous source driver (driver IC) manufacturers have joined the ranks of P2P protocol development. The source output enable signal (source output enable/latch signal/TP) in the point-to-point transmission protocol has a great influence on a charging time of liquid crystals, and affects timing of data.

Due to differences in the development and design of the settings of the source output enable signal in the P2P protocol by different manufacturers, when the LCD panel factory switches between driver ICs supplied by different manufacturers, the TP settings cannot be shared, resulting in differences in charging times and affects display panels.

### SUMMARY OF INVENTION

The present application provides an array substrate to solve a problem of that when the LCD panel factory switches the Driver IC supplied by different manufacturers, and the TP settings cannot be shared to make differences between the charging time.

In a first aspect, the present application provides a driving method of a display panel, the method includes: pre-storing a new setting information of a source output enable signal in a peer-to-peer protocol of a time schedule controller; a detection module of a source driver conducting an identification procedure to a default setting information of the source output enable signal; and an output module of the source driver invoking and outputting the new setting information according to a detection result.

In combination with the first aspect, in a first embodiment of the first aspect, the new setting information comprises a first new setting information and a second new setting information; the default setting information comprises a default high level start time and a default high level hold time; when the default high level start time and/or the default high level hold time are/is 0, the output module invokes and outputs the first new setting information: when both of the default high level start time and the default high level hold time are not 0, the output module invokes and outputs the second new setting information.

In combination with the first embodiment of the first aspect, in a second embodiment of the first aspect, the first new setting information comprises a fixed new high level start time and a fixed new high level hold time; wherein the fixed new high level start time is a S packet; the fixed new high level hold time is a L packet; and both S and L are positive integers.

In combination with the first embodiment of the first aspect, in a third embodiment of the first aspect, the second new setting information comprises a variable new high level start time and a variable new high level hold time; wherein the variable new high level start time is set according to the default high level start time; the variable new high level hold time is set according to the default high level hold time.

In combination with the third embodiment of the first aspect, in a fourth embodiment of the first aspect, the step of the variable new high level start time set according to the default high level start time comprises: when the default high level start time is not greater than a X packet, the variable new high level start time is a Y packet; and when the default high level start time is greater than the X packet, the variable new high level start time is same as the default high level start time; wherein X and Y are positive integers.

In combination with the third embodiment of the first aspect, in a fifth embodiment of the first aspect, the step of the variable new high level hold time set according to default high level hold time comprises: when the default high level hold time is not greater than a M packet, the variable new high level hold time is a N packet; and when the default high level hold time is greater than a M packet, the variable new high level hold time is same as the default high level hold time; wherein both M and N are positive integers.

In a second aspect, the present application provides a driving system of a display panel, the system includes a time schedule controller configured for pre-storing a default setting information and a new setting information of a source output enable signal in a peer-to-peer protocol; and a source driver connecting to an output end of the time schedule controller via the peer-to-peer protocol and configured for detecting and executing the new setting information according to the default setting information.

In combination with the second aspect, in a first embodiment of the second aspect, the source driver comprises: a detection module connecting to the output end of the time schedule controller and configured for detecting and outputting an executing command according to the default setting information; and an output module connecting to an output end of the detection module and configured for receipting and outputting the new setting information according to the executing command

In combination with the first embodiment of the second aspect, in a second embodiment of the second aspect, the time schedule controller includes a storage unit; the default setting information and the new setting information are pre-stored in the storage unit.

In a third aspect, the present application provides a storage medium, a plurality of commands is stored in the storage medium, the commands are configured for the processors to execute any of the driving methods of the display panel of the above.

The benefit of the present application is: a driving method of a display panel is provided in the present application, by pre-storing a new setting information of a source output enable signal in a peer-to-peer protocol, and detecting the default setting information of the source output enable signal, and according to a detecting result of the default setting information, invoking the new setting information, when switching different drivers, a setting information of the source output enable signal in the peer-to-peer protocol can be unified, thereby avoiding the charging time difference due to the replacement of drivers.

### BRIEF DESCRIPTION OF DRAWINGS

FIG. 1 is a flow chart of a driving method of a display panel of one embodiment of the present application.

FIG. 2 is a schematic diagram of one step of the driving method of the display panel of FIG. 1.

FIG. 3 is a structural schematic diagram of a driving system of a display panel of one embodiment of the present application.

FIG. 4 is another structural schematic diagram of the driving system of the display panel of one embodiment of the present application.

### DETAILED DESCRIPTION OF PREFERRED EMBODIMENTS

In order to make the purpose, technical solutions and effects of the present application clearer, the present application will be described in further detail below with reference to the accompanying drawings and examples. It should be understood that the specific embodiments described herein are only used to explain the present application, and are not used to limit the present application.

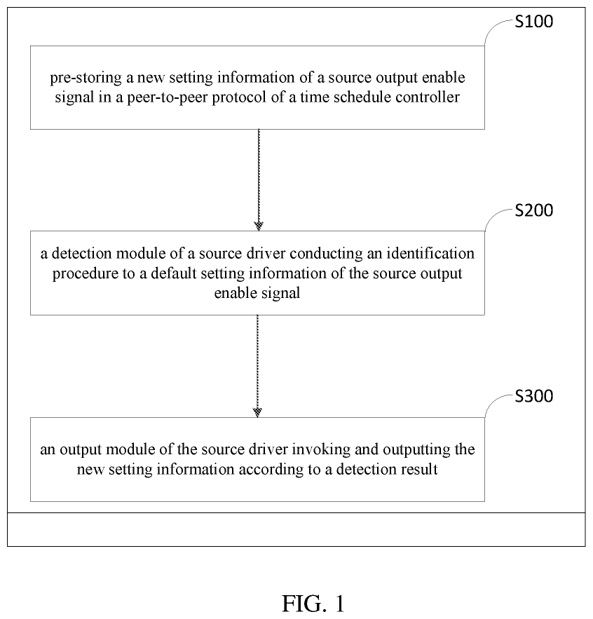

Referring to FIG. 1, the present embodiment provides a driving method of a display panel. The driving method of the display panel includes the following steps:

a step S100 of pre-storing a new setting information of a source output enable signal in a peer-to-peer (P2P) protocol of a time schedule controller 100;

a step S200 of a detection module 210 of a source driver 200 conducting an identification procedure to a default setting information of the source output enable signal; and

a step S300 of an output module 220 of the source driver 200 invoking and outputting the new setting information according to a detection result.

Specifically, the new setting information of the source output enable signal in the peer-to-peer protocol is stored in a corresponding medium of the time schedule controller 100, in operation, the source driver 200 will detect the default setting information of the source output enable signal, when it finds that the default setting information of the source output enable signal of the source driver 200 meets a specific requirement, the new setting information of the source output enable signal will be invoked to modify the default setting information executed in the source driver 200; therefore, when replacing drivers of other manufacturers, even if there are differences among the default setting information of the source output enable signal of the source driver 200 of other manufacturers, this method can ensure the source output enable signal execute the new setting information and avoid a COF charging time difference due to a replacement of the source driver 200.

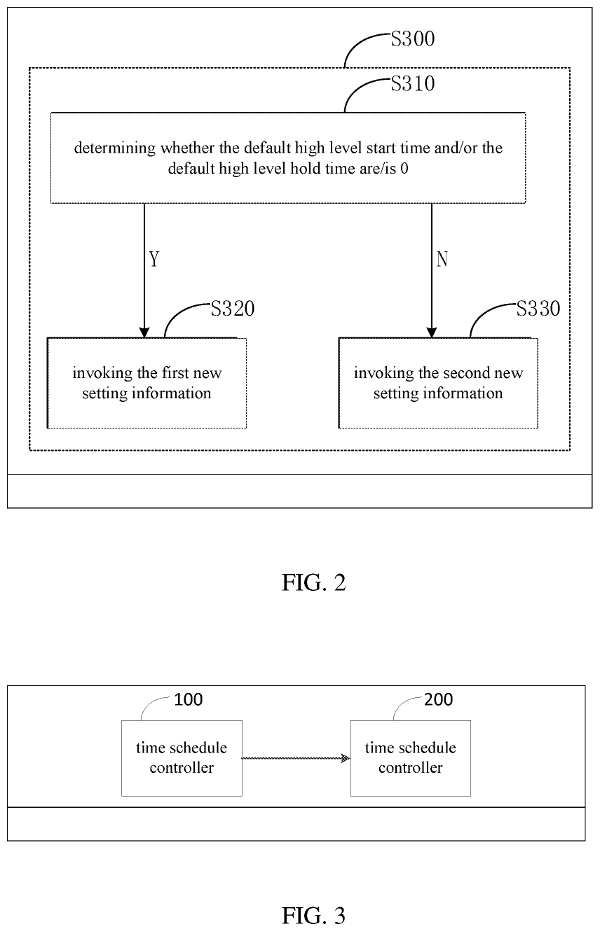

Referring to FIG. 2, in one embodiment, the new setting information includes a first new setting information and the second new setting information; the default setting information includes a default high level start time and a default high level hold time; a step S310: when the default high level start time and/or the default high level hold time are/is 0; executing a step S320: the output module 220 invokes and outputs the first new setting information; the step S310: when both of the default high level start time and the default high level hold time are not 0, a step S330 is executed: the output module 220 invokes and outputs the second new setting information.

Specifically, the source output enable signal is a pulse which is used to control the output of the source driver 200, which includes two critical parameters: the high level start time (TPD) and the high level hold time (TPW), the two parameters affect a data timing and a charging time of a liquid crystal, wherein the high level start time (TPD) is a start time corresponding to a rising edge of the pulse, the high level hold time (TPW) is a hold time between the rising edge of the pulse and a falling edge of the pulse. The source driver 200 will perform actions by detecting the rising edge and falling edge of the TP signal. In this embodiment, both the new setting information and the default setting information includes these two parameters. The step S310: when the default high level start time and/or the default high level hold time are/is 0, that is if any of or all of the default high level start times and/or the default high level hold times are/is 0, the first new setting information is invoked and outputted by via a P2P protocol, at this time, the source driver 200 outputs a signal according to the first new setting information; otherwise, the source driver 200 outputs a signal according to the second new setting information.

In one embodiment, the first new setting information includes a fixed new high level start time and a fixed new high level hold time; wherein the fixed new high level start time is an S packet; the fixed new high level hold time is an L packet; both S and L are positive integers.

Specifically, a packet is a time unit in relation to the number of bits of each byte and the clock frequency transferred by the P2P protocol. For example, S may be but not limited to 20, and L may be but not limited to 100.

In one embodiment, the second new setting information includes a variable new high level start time and a variable new high level hold time; the variable new high level start time is set according to the default high level start time; the variable new high level hold time is set according to the default high level hold time.

Specifically, the variable new high level start time is set according to the default high level start time, the variable new high level hold time is set according to the default high level hold time.

Referring to Table 1, in one embodiment, the step of the variable new high level start time set according to the default high level start time includes: when the default high level start time is not greater than an X packet, the variable new high level start time is a Y packet; when the default high level start time is greater than the X packet, the variable new high level start time is same as the default high level start time; wherein X and Y are positive integers.

TABLE 1
Setting of TPD

| default high level start time | variable new high level start time |
|---|---|
| 0000 0001 | 20 packet |
| . . . | |
| 0001 0100 | |
| 0001 0101 | 21 packet |
| . . . | . . . |
| 1111 1111 | 255 packet |

TABLE 2
Setting of TPW

| default high level hold time | variable new high level hold time |
|---|---|
| 0000 0001 | 10 packet |
| . | |
| . | |
| . | |
| 0000 1010 | |
| 0000 1011 | 11 packet |
| . . . | . . . |
| 1111 1111 | 255 packet |

Specifically, when X is from 0000 0001 to 001 0100, that is 1-20 in the decimal system, Y is 20; when X is from 0001 0101 to 1111 1111, that is 21-255 in the decimal system, the variable new high level start time is same as the default high level start time. The values here are for example only and are not intended to limit any specific values. The values of the TPD and the TPW are controlled and adjusted respectively by 8 bits in the binary data, the 8 bits in the binary data in this example are interpreted from a P2P signal which is used to define the value of the TPD and the TPW.

Referring to Table 2, in one embodiment, the step of the variable new high level hold time set according to default high level hold time includes: when the default high level hold time is not greater than an M packet, the variable new high level hold time is an N packet; when the default high level hold time is greater than the M packet, the variable new high level hold time is same as the default high level hold time; wherein both M and N are positive integers.

Specifically, when M is from 0000 0001 to 0000 1010, that is 1-10 in the decimal system, N is 10; when M is from 0000 1011 to 1111 1111, that is 11-255 in the decimal system, the variable new high level hold time is same as the default high level hold time. The values here are for example only and are not intended to limit any specific values.

Referring to FIG. 3, in one embodiment, the present application provides a driving system of a display panel. The driving system of the display panel includes: the time schedule controller 100 configured for pre-storing the default setting information and the new setting information of the source output enable signal in the peer-to-peer protocol; and the source driver 200 connecting to an output end of the time schedule controller 100 via the peer-to-peer protocol and configured for detecting and executing the new setting information according to the default setting information.

Specifically, the time schedule controller 100 and the source driver 200 are connected through a communication transmission line (TX). The time schedule controller 100 reads the default setting information and packages it into a P2P signal, the source driver 200 then identifies the default setting information of the source output enable signal contained in the P2P signal and sends the default setting information of the source output enable signal to the source driver 200, the source driver 200 detects the default setting information in order to identify a code corresponding the default setting information, based on a code detection result, the source driver 200 executes according to the new setting information by the new setting information stored in the time schedule controller 100 invoked by the P2P protocol.

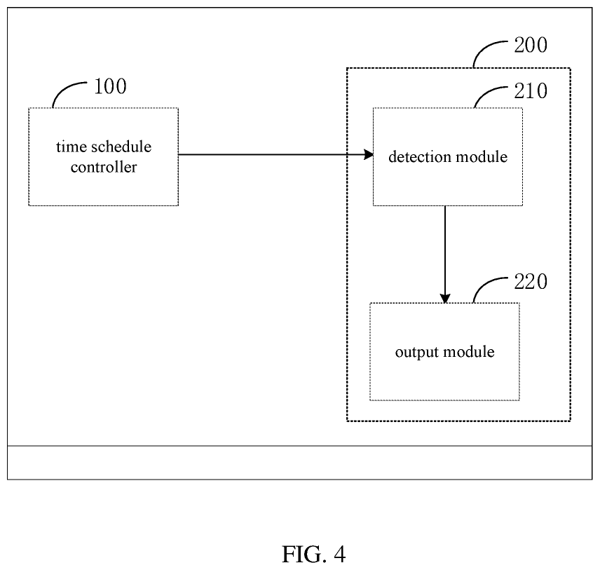

Referring to FIG. 4, in one embodiment, the source driver 200 includes: a detection module 210 connecting to the output end of the time schedule controller 100 and configured for detecting and outputting an executing command according to the default setting information; and the output module 220 connecting to an output end of the detection module 210 and configured for receiving and outputting the new setting information according to the executing command.

Specifically, the detection module 210 conducts a code identification to the default setting information and sends an execution command according to the code identification result, based on the execution command, the output module 220 invokes the new setting information stored in the time schedule controller 100 by the P2P protocol, so that the source driver 200 drives a liquid crystal display according to the new setting information and avoids driving the liquid crystal display according to the source output enable signal by itself.

In one embodiment, the time schedule controller 100 includes the storage unit; the default setting information and the new setting information are pre-stored in the storage unit.

Specifically, the storage unit can be a storage module or a register of the time schedule controller 100, as well as an extra storage medium, it is configured for storing the default setting information and the new setting information of the source output enable signal in the P2P protocol, which makes it more convenient to invoke the new setting information through the P2P protocol when replacing the source driver 200 from other manufacturers.

In one embodiment, a storage medium is provided, a plurality of commands is stored in the storage medium, the commands are configured for the processors to execute any of the driving methods of the display panel depicted above.

The driving method of the display panel is provided in the present application, by pre-storing the new setting information of the source output enable signal in the peer-to-peer protocol, and detecting the default setting information of the source output enable signal, and according to a detecting result of the default setting information, invoking the new setting information, when switching different drivers, the setting information of the source output enable signal in the peer-to-peer protocol can be unified, thereby avoiding the charging time difference due to a replacement of drivers.

It can be understood that, for those of ordinary skill in the art, equivalent replacements or changes can be made according to the technical solutions and inventive concepts of the present application, and all such changes or replacements should belong to the claims attached to the present application protected range.

What is claimed is:

1. A driving method of a display panel, comprising:
pre-storing a new setting information of a source output enable signal in a peer-to-peer protocol of a time schedule controller;
a detection module of a source driver conducting an identification procedure on a default setting information of the source output enable signal; and
an output module of the source driver invoking and outputting the new setting information according to a detection result.

2. The driving method of the display panel of claim 1, wherein the new setting information comprises a first new setting information and a second new setting information;
the default setting information comprises a default high level start time and a default high level hold time;
when the default high level start time and/or the default high level hold time are/is 0, the output module invokes and outputs the first new setting information; and
when both of the default high level start time and the default high level hold time are not 0, the output module invokes and outputs the second new setting information.

3. The driving method of the display panel of claim 2, wherein the first new setting information comprises a fixed new high level start time and a fixed new high level hold time;
wherein the fixed new high level start time is a S packet;
the fixed new high level hold time is a L packet; and
both S and L are positive integers.

4. The driving method of the display panel of claim 2, wherein the second new setting information comprises a variable new high level start time and a variable new high level hold time; and
wherein the variable new high level start time is set according to the default high level start time; the variable new high level hold time is set according to the default high level hold time.

5. The driving method of the display panel of claim 4, wherein the step of the variable new high level start time is set according to the default high level start time comprises:
when the default high level start time is not greater than a X packet, the variable new high level start time is a Y packet;
when the default high level start time is greater than the X packet, the variable new high level start time is same as the default high level start time; and
wherein X and Y are positive integers.

6. The driving method of the display panel of claim 4, wherein the step of the variable new high level hold time is set according to the default high level hold time comprises:
when the default high level hold time is not greater than an M packet, the variable new high level hold time is an N packet;
when the default high level hold time is greater than the M packet, the variable new high level hold time is same as the default high level hold time; and
wherein both M and N are positive integers.

7. A driving system of a display panel, comprising:
a time schedule controller configured for pre-storing a default setting information and a new setting information of a source output enable signal in a peer-to-peer protocol; and
a source driver connecting to an output end of the time schedule controller via the peer-to-peer protocol and configured for detecting and executing the new setting information according to the default setting information.

8. The driving system of the display panel of claim 7, wherein the source driver comprises:
a detection module connecting to the output end of the time schedule controller and configured for detecting and outputting an execute command according to the default setting information; and
an output module connecting to an output end of the detection module and configured for receiving and outputting the new setting information according to the executing command

9. The driving system of the display panel of claim 8, wherein the time schedule controller includes a storage unit;
the default setting information and the new setting information are pre-stored in the storage unit.

10. The driving system of the display panel of claim 9, wherein the new setting information comprises a first new setting information and a second new setting information;
the default setting information comprises a default high level start time and a default high level hold time;
when the default high level start time and/or the default high level hold time are/is 0, the output module invokes and outputs the first new setting information; and
when both of the default high level start time and the default high level hold time are not 0, the output module invokes and outputs the second new setting information.

11. The driving system of the display panel of claim 10, wherein the first new setting information comprises a fixed new high level start time and a fixed new high level hold time;
wherein the fixed new high level start time is an S packet;
the fixed new high level hold time is an L packet; and
both S and L are positive integers.

12. The driving system of the display panel of claim 10, wherein the second new setting information comprises a variable new high level start time and a variable new high level hold time; and
wherein the variable new high level start time is set according to the default high level start time; the variable new high level hold time is set according to the default high level hold time.

13. The driving system of the display panel of claim 12, wherein the step of the variable new high level start time set according to the default high level start time comprises:
when the default high level start time is not greater than an X packet, the variable new high level start time is a Y packet;
when the default high level start time is greater than the X packet, the variable new high level start time is same as the default high level start time; and
wherein X and Y are positive integers.

14. The driving system of the display panel of claim 12, wherein the step of the variable new high level hold time set according to default high level hold time comprises:
when the default high level hold time is not greater than an M packet, the variable new high level hold time is an N packet; when the default high level hold time is greater than the M packet, the variable new high level hold time is same as the default high level hold time; and
wherein both M and N are positive integers.

15. A storage medium, wherein a plurality of commands is stored in the storage medium, the commands are configured for the processors to execute the driving methods of the display panel of claim 1.

16. The storage medium of claim 15, wherein the source output enable signal is a pulse and is used to control the output of the source driver.

17. The storage medium of claim 16, wherein the new setting information comprises a first new setting information and a second new setting information;
the default setting information comprises a default high level start time and a default high level hold time;
when the default high level start time and/or the default high level hold time are/is 0, the output module invokes and outputs the first new setting information; and
when both of the default high level start time and the default high level hold time are not 0, the output module invokes and outputs the second new setting information.

18. The storage medium of claim 17, wherein the first new setting information comprises a fixed new high level start time and a fixed new high level hold time;
wherein the fixed new high level start time is an S packet;
the fixed new high level hold time is an L packet; and
S is 20; and L is 100.
